(19) United States
(12) Patent Application Publication
(10) Pub. No.: US 2018/0206675 A1
(43) Pub. Date: Jul. 26, 2018

(54) TOOTHLESS HERB GRINDER SYSTEM

(71) Applicant: 9223851 Canada Inc., Laval (CA)

(72) Inventor: Christopher Mennillo, Rosemere (CA)

(21) Appl. No.: 15/411,056

(22) Filed: Jan. 20, 2017

(51) Int. Cl. A47J 42/14; A47J 42/20; A24B 7/00

(52) U.S. Cl. CPC A47J 42/14; A24B 7/00; A47J 42/20

(57) ABSTRACT

The present invention involves a system and method for grinding herbs, tobacco, marijuana and the like. The toothless herb grinder system comes in two preferred embodiments one of two piece and one of four pieces. The first embodiment of the toothless herb grinder system herein is comprised of two textured halves used for the compression and grinding process. The upper and lower halves are toothless, as they are carved with maze pattern system to shred the herbs placed in the grinder. The upper half is made of a convex maze pattern. The lower half is concave and the maze pattern is carved at the bottom of an internal bore. The material to be ground is placed and received at the bottom of the lower half. The second embodiment of the toothless herb grinder system herein is comprised of a top member, two tubular housing members and a bottom lid member. The top member is made of a convex maze pattern. The first tubular housing member having a grinding disk in the middle of its internal bore. The material to be ground is placed in the first tubular housing member, on top of the grinding disk. This construction provides an increased rapidity, uniformity and fineness of the grinding, when compared to grinders using a vertical teeth system

### BACKGROUND AND SUMMARY

In general, tobacco and botanical herb grinders are cylindrical devices divided into two halves with sharp pegs or teeth aligned such that when the halves are rotated with respect to each other, the material inside is shredded. Herb grinders are made from wood, plastic or metal, and may be manual or electric. They are commonly used for refining marijuana or tobacco, as well as in the kitchen for crushing spices and herbs.

A grinder of background interest is shown in CA 02904961. In this device the herb grinder system includes interchangeable and replaceable grinder plates that are secured with threading. The upper and lower grinding plates of that device are provided with blades having a modified diamond shape which served to shred the herbs and materials. However, said patent fails to create a simple but efficient herb grinder system. The present invention is simpler for the end-user which doesn't have to extensively clean or change the grinding plates because the toothless herb grinder system only uses concave radiuses, carved into the grinding disks, instead of using teeth or pegs.

Finally, there are ergonomic needs that an herb grinder system must satisfy in order to achieve acceptance by the end user. The system must be easily and quickly assembled using minimal hardware and requiring a minimal number of tools. Further, the herb grinder system should not require excessive strength to assemble or include cumbersome and difficult to use component parts. Moreover, the system must assemble together in such a way so as not to detract from the aesthetic appearance of the herb grinder system.

Thus, the present invention provides a toothless herb grinder system which overcomes the disadvantages of prior art grinder devices. The toothless herb grinder system particularly differs from prior art device with respect to the aspect that it contains no tooth so to speak. Instead of using vertically aligned teeth or pegs to shred the herbs, the toothless herb grinder system obtains its grinding effect with the compression of two textured hard disks. The present invention uses friction instead of sharpness. The present invention not only provides for significant ease in assembly and use, it increases the rapidity, uniformity and fineness of the grinding. The present invention also broadens the use, from simple tobacco to herbs and grains.

### SUMMARY OF THE INVENTION

Briefly, the present invention involves a system and method for grinding herbs, tobacco, marijuana and the like. The first embodiment of the toothless herb grinder system herein includes an upper and lower half including a tubular housing member. The lower half is concave and features a carved maze pattern integrally formed in the bottom of the lower half. The upper half is convex and features a carved maze pattern integrally formed to the said upper half. The maze pattern carvings are made of lines or other shapes which are repeated along the radius. Carved between these lines and other shapes is a concave radius. This concave radius allows the user to grind the herbs. The shape or form created by the concave radius is repeated around the center the upper or lower half. When the upper half is being pressed inside the lower half with a rotating motion, it creates a scissoring intersection between the two patterns. The concave portions of the lower half also provide deep areas for collecting the ground material. The second embodiment of the toothless herb grinder system herein includes a top member, a first tubular housing member, a second tubular housing member and a bottom lid member. The top member is convex and features a carved maze pattern integrally formed to the bottom portion of said top member. The first tubular housing member is concave, includes an internal bore separated in two, upper and lower internal bores, and features a grinding disk including a carved maze pattern integrally formed to the said first tubular housing member. The maze pattern carvings are made of lines or other shapes which are repeated along the radius. Carved between this lines and other shapes is a concave radius. This concave radius allows the user to grind the herbs. The shape or form created by the concave radius is repeated around the center of the top member and first tubular housing member. When the top member is being pressed inside the first tubular housing member with a rotating motion, it creates a scissoring intersection between the two patterns. The grinding disk located in the first tubular housing member also features sized apertures for the sieving of the ground material. The ground material then falls through the second tubular housing member and can be stored as the toothless herb grinder system is sealed by the lid bottom member. These features give the user greater ability to select and customize the grinding of their tobacco and botanical herbs.

Accordingly, it is an objective of the present invention to provide a toothless herb grinder system.

It is a further objective of the present invention to provide a toothless herb grinder system that includes no teeth or pegs to shred the herbs.

It is yet a further objective of the present invention to provide a toothless herb grinder system that includes grinding disks integrally formed to the member of the toothless herb grinder system, eliminating the need to replace or change traditional grinding plates.

It is another objective of the present invention to provide a toothless herb grinder system that provides for storage of ground herbs and the like within the bottom portion of the concave radiuses of the bottom member for the first embodiment of the toothless herb grinder system and within the second tubular housing member for the second embodiment of the toothless herb grinder system.

Other objectives and advantages of this invention will become apparent from the following description taken in conjunction with the accompanying drawings wherein are set forth, by way of illustration and example, certain embodiments of this invention. The drawings constitute a part of this specification and include exemplary embodiments of the present invention and illustrate various objects and features thereof.

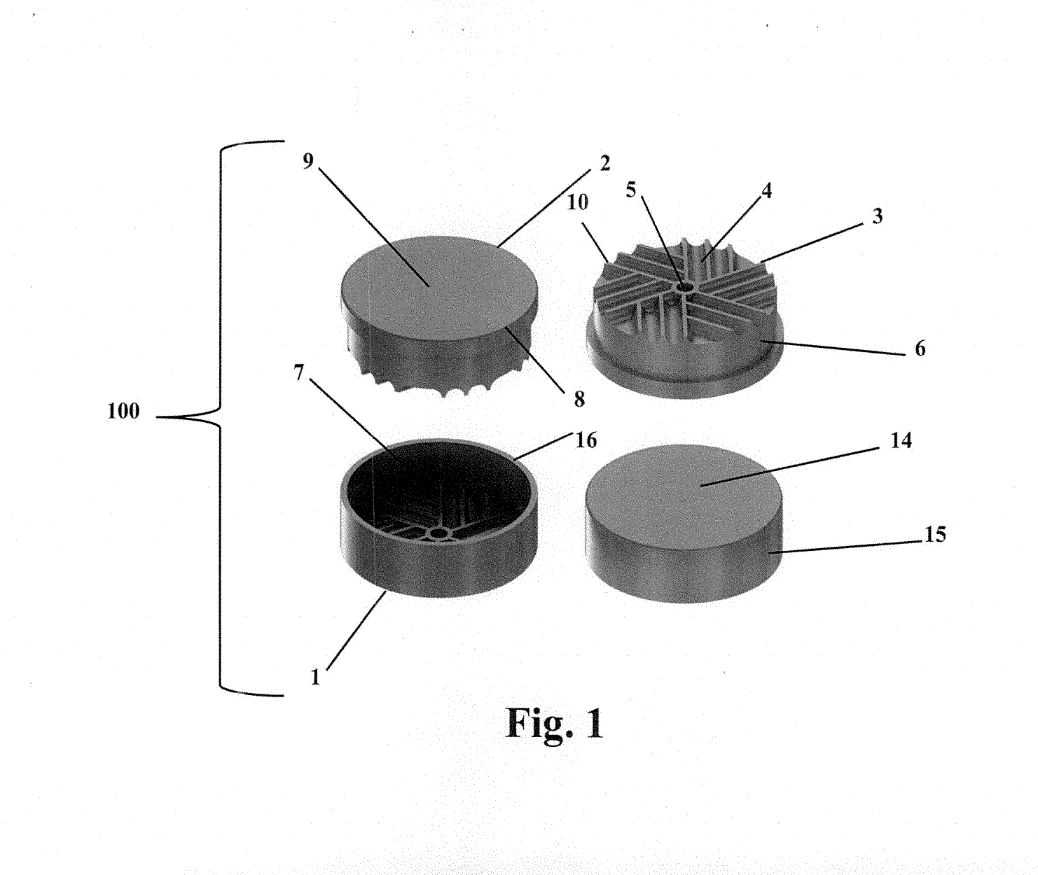

FIG. 1 is an exploded isometric view illustrating the first embodiment of a toothless herb grinder system seen from the top and from the bottom;

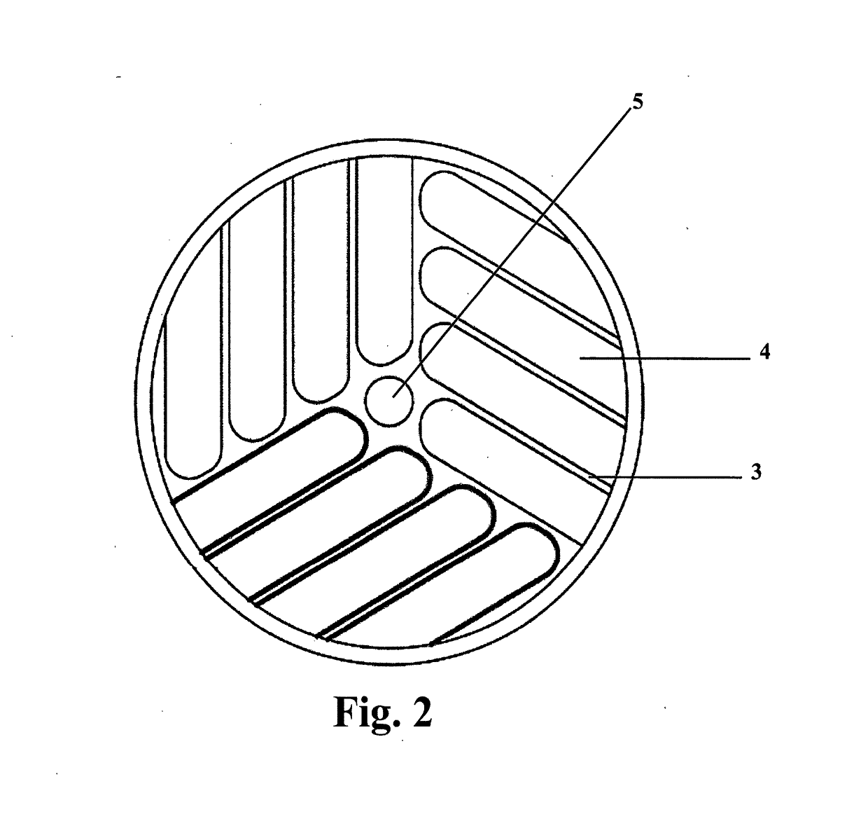

FIG. 2 is a plan view of the maze pattern illustrated in FIG. 1;

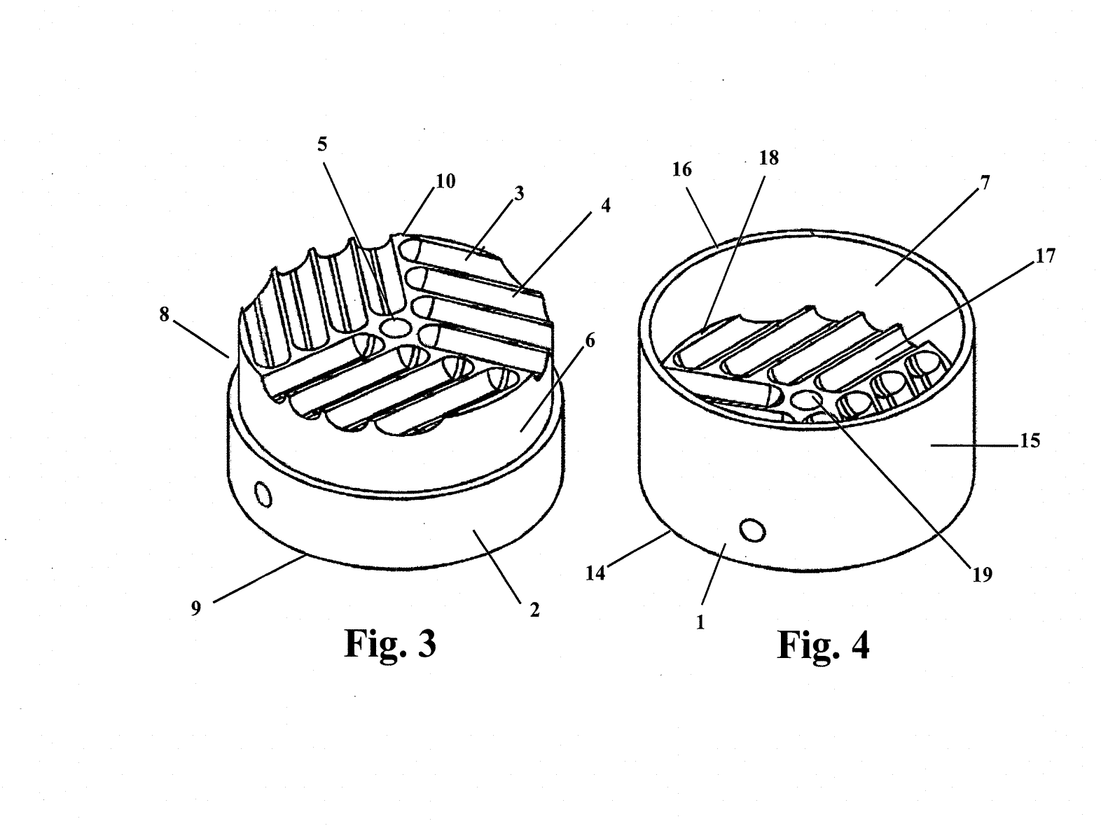

FIG. 3 is an isometric view of the top member of the first embodiment of the toothless herb grinder system;

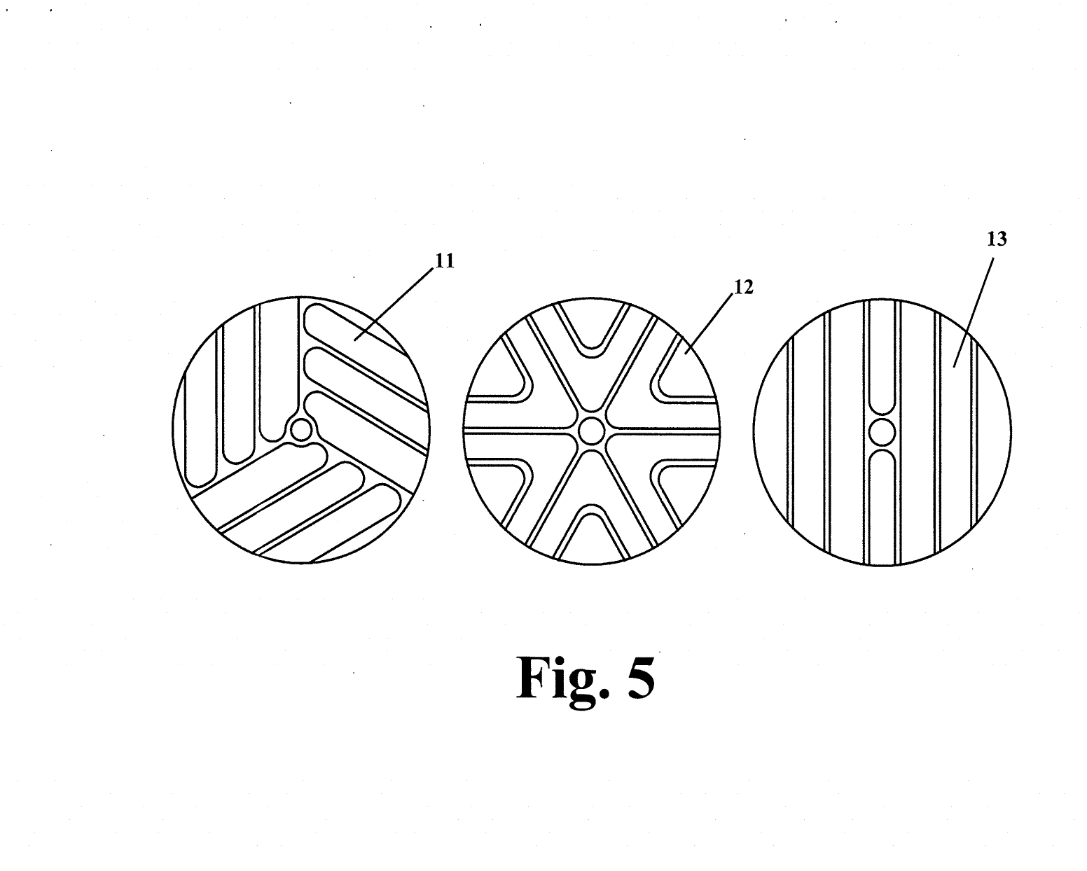

FIG. 4 is an isometric view of the bottom member of the first embodiment of the toothless herb grinder system;

FIG. 5 is a plan view of the different maze patterns for the present invention;

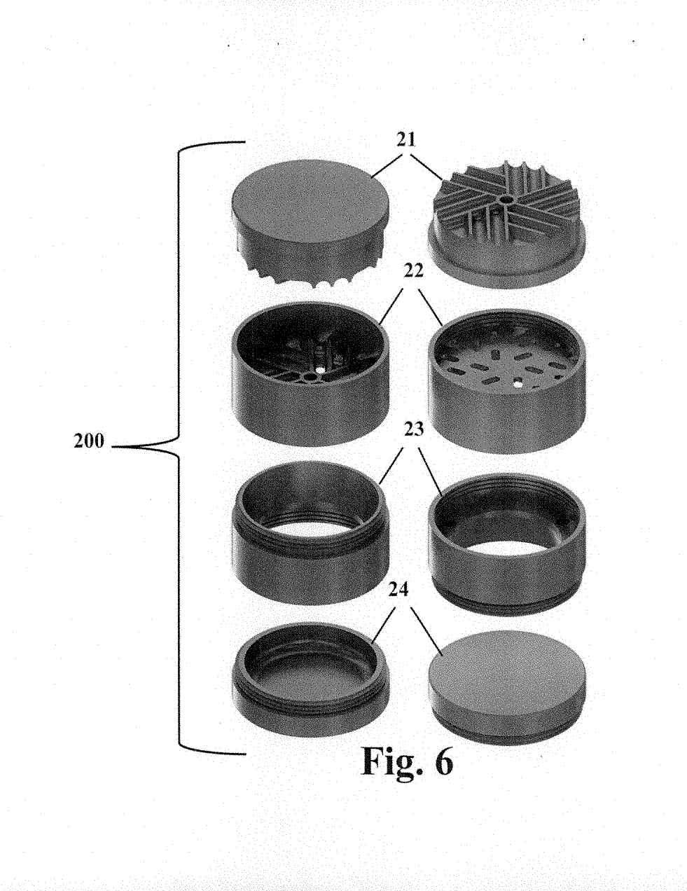

FIG. 6 is an exploded isometric view illustrating the second embodiment of a toothless herb grinder system seen from the top and from the bottom;

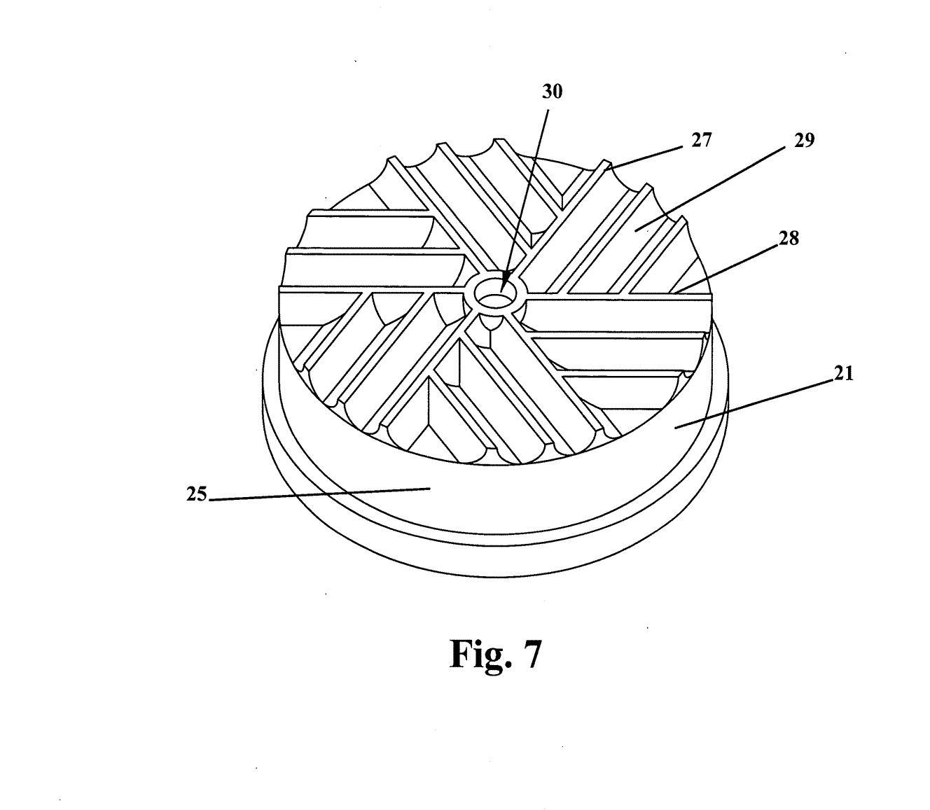

FIG. 7 is an isometric view and side plan view of the top member of the second embodiment of the toothless herb grinder system;

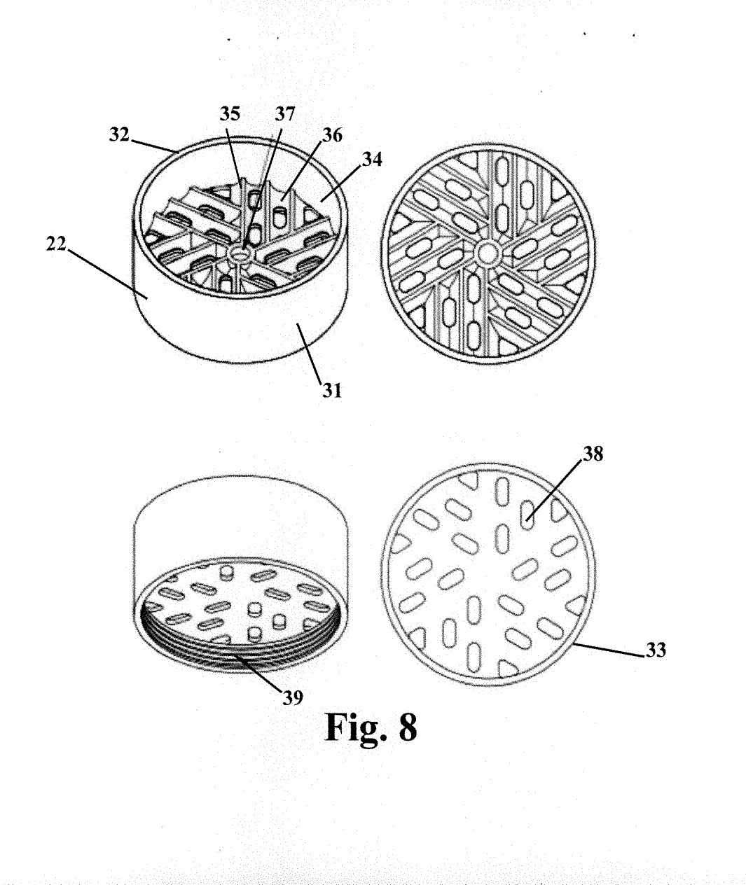

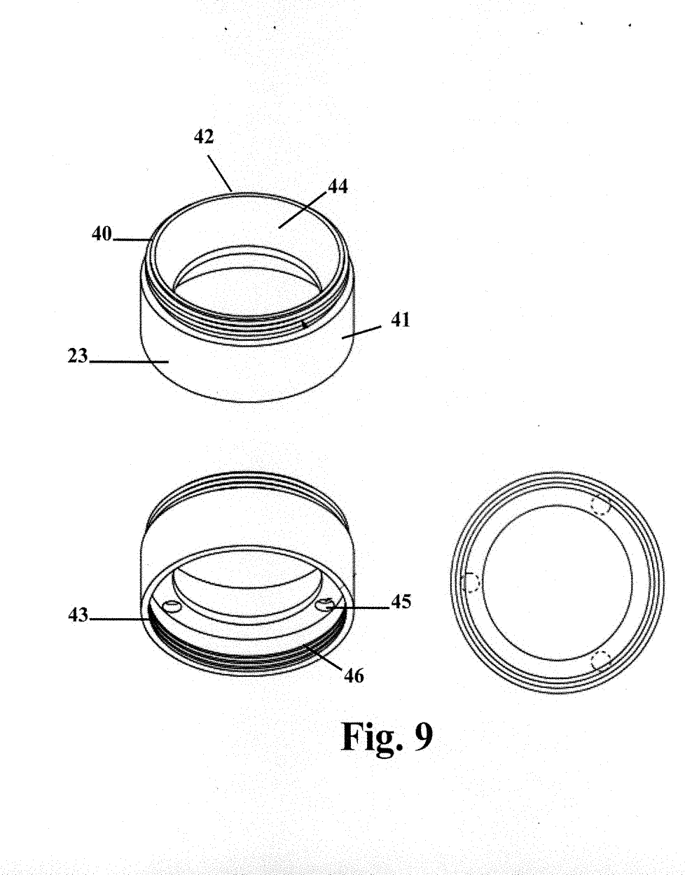

FIG. 8 is an isometric view seen from the top and from the bottom, a side plan view, a top plan view and a bottom plan view of the first tubular housing member of the second embodiment of the toothless herb grinder system;

FIG. 9 is an isometric view seen from the top and from the bottom, a side plan view and a top plan view of the second tubular housing member of the second embodiment of the toothless herb grinder system;

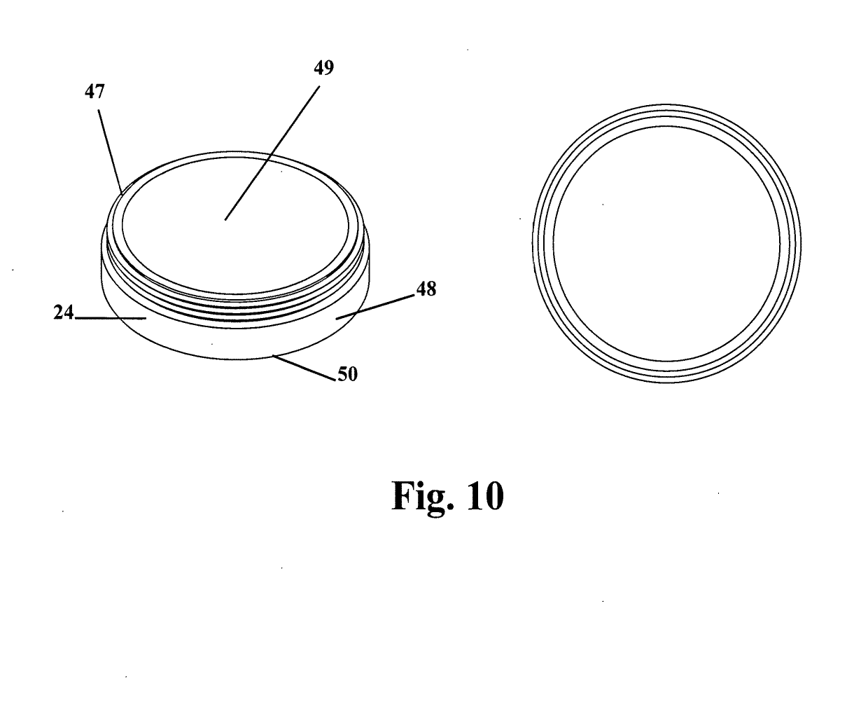

FIG. 10 is an isometric view seen from the top, a side plan view and a top plan view of the bottom lid member of the second embodiment of the toothless herb grinder system;

### DETAILED DESCRIPTION

In this description, references to “top”, “bottom”, “upper”, “lower” and the like merely refer to the relative positions of the elements and parts of the grinder in the figures, and do not restrict the positioning of the elements and parts in actual use.

While the present invention is susceptible of embodiment in various forms, there is shown in the drawings and will hereinafter be described a presently preferred embodiment with the understanding that the present disclosure is to be considered an exemplification of the invention and is not intended to limit the invention to the specific embodiments illustrated.

Referring to FIGS. 1-5, the first embodiment of the toothless herb grinder system [100] is illustrated. The toothless herb grinder system is useful for grinding herbs, tobacco, marijuana and the like. The preferred embodiment of the toothless herb grinder system includes a top member [2] and a bottom member [1].

Referring to FIGS. 1, 2, 3 and 5 the top member [2] is illustrated. The top member [2] includes an outer surface [8], a top surface [9], a bottom surface [10] and a cylindrical convex carved maze pattern [6] integrally formed to said top member. The cylindrical convex carved maze pattern [6] includes concave radiuses [4] that can take a variety of shapes [11], [12], [13]. These concave radiuses [4] are positioned along the bottom surface [10] and repeated around the center [5], to cause each concave radius [4] to be a concave beveled cutting edge when the top member [2] is pressed in a rotating motion against the bottom of the internal bore [7] of the bottom member [1].

Referring to FIGS. 1, 2, 4 and 5, the bottom member [1] is illustrated. The bottom member [1] includes a bottom surface [14], an outer surface [15], a top surface [16] and an internal bore [7] featuring a carved maze pattern [17] at the bottom portion of said internal bore [7]. The carved maze pattern [17] is integrally formed to said bottom member [1]. The carved maze pattern [17] includes concave radiuses [18] that can take a variety of shapes [11], [12], [13]. These concave radiuses [18] are positioned along bottom surface of the internal bore [7] and are repeated around the center [19] to cause each concave radius [18] to be a concave beveled cutting edge when the bottom member [1] is pressed in a rotating motion against the top member [2].

Referring to FIGS. 5-10, the second embodiment of the toothless herb grinder system [200] is illustrated. The toothless herb grinder system is useful for grinding herbs, tobacco, marijuana and the like. The preferred embodiment of the toothless herb grinder system includes a top member [21], a first tubular housing member [22], a second tubular housing member [23] and a bottom member [24].

Referring to FIGS. 5 to 7, the top member [21] is illustrated. The top member [21] includes an outer surface [25], a top surface [26], a bottom surface [27] and a cylindrical convex carved maze pattern [28] integrally formed to said top member [21]. The cylindrical carved convex maze pattern [28] includes concave radiuses [29] that can take a variety of shapes [11], [12], [13]. These concave radiuses [29] are positioned along the bottom surface [27] and are repeated around the center [30] to cause each concave radius [29] to be a concave beveled cutting edge when the top member [21] is pressed in a rotating motion against the first tubular housing member [22].

Referring to FIGS. 5, 6, 8 and 9, the first tubular housing member [22] is illustrated. The first tubular housing member [22] includes an outer surface [31], a top surface [32], a bottom surface [33] and an internal bore [34] featuring a carved maze pattern [35] at the bottom portion of said upper internal bore [34]. The carved maze pattern [35] is integrally formed to said first tubular housing member [22]. The carved maze pattern [35] includes concave radiuses [36] that can take a variety of shapes [11], [12], [13]. These concave radiuses [36] are positioned along the upper surface the grinding disk in said bottom portion of the upper internal bore [34] and are repeated around the center [37], to cause each concave radius [36] to be a concave beveled cutting edge when the first tubular housing member [22] is pressed in a rotating motion against the top member [21]. The grinding disk also features sized apertures [38], for the sieving of the ground material. The lower internal bore includes internal engaging structures [39] for the cooperation with the conjugate engaging structures [40] of the second tubular housing member [23] to secure the first tubular housing member [22] in a position juxtaposed to the second tubular housing member [23].

Referring to FIGS. 6, 8, 9 and 10, the second tubular housing member [23] is illustrated. The second tubular housing member [23] includes an outer surface [41], a top surface [42], a bottom surface [43] and an internal bore [44]. The top surface [42] having conjugate engaging structures [40] for the cooperation with the internal engaging structures [39] of the first tubular housing member [22] to secure said first tubular housing member [22] in a position juxtaposed to the second tubular housing member [23]. The bottom surface [43] having internal engaging structures [46] to cooperate with the conjugate engaging structures [47] of the bottom lid member [24] to secure the second tubular housing member [23] in a position juxtaposed to the bottom lid member [24].

Referring to FIGS. 6, 9 and 10, the bottom lid member [24] is illustrated. The bottom lid member [24] includes an outer surface [48], a top surface [49] and a bottom surface [50]. The top surface [49] having conjugate engaging structures [47] to cooperate with the internal engaging structures [46] of the second tubular housing member [23] to secure said second tubular housing member [23] in a position juxtaposed to the bottom lid member [24]

What is claimed:

1. A first embodiment of the toothless herb grinder system comprising:
a bottom member including an internal bore, an outer surface, a top surface and a lower surface, the bottom portion of said internal bore having a carved maze pattern integrally formed to said bottom portion,
a top member including an outer surface, a top surface and the bottom portion of said top member having cylindrical convex carved maze pattern integrally formed to said top member,
said cylindrical convex carved maze pattern of the top member is cylindrical in shape having an outer diameter surface that is sized to fit within said bottom portion of said internal bore of said bottom member.

2. The toothless herb grinder system of claim 1 wherein the bottom portion of the top member and the bottom portion of the internal bore of said bottom member include maze pattern carvings when viewed from the top, whereby lines or other shapes are repeated along the radius, said lines or other shapes create a concave radius, said concave radius is repeated around the center of said top member and bottom portion of said internal bore of said bottom member, said concave radiuses are positioned to be a concave beveled cutting edge when the bottom portion of said top member is being pressed against the bottom portion of said internal bore with a rotating motion creating the scissoring intersection of the two patterns, said bottom portion of said of internal bore also provides deep areas for collecting the ground material.

3. A second embodiment of the toothless herb grinder system comprising:
A first tubular housing member including an outer surface, a top surface, bottom surface, upper internal bore and lower internal bore, said tubular housing member including a grinding disk located at the middle separating upper and lower internal bores,
said lower internal bore having internal engaging structures for cooperation with the conjugate engaging structures of second tubular housing member to secure said bottom surface of said first tubular housing member at a position juxtaposed to the top surface of said second tubular housing member,
said grinding disk at the bottom portion of the upper internal bore including a carved maze pattern having a plurality of sized apertures integrally formed to said tubular housing member,
a second tubular housing member including, an outer surface, a top surface, a lower surface and an internal bore, the top surface of said second tubular housing member having conjugate engaging structures for cooperation with the internal engaging structures within the first tubular housing member, said lower surface of said second tubular housing member including internal engaging structures for cooperation with the conjugate engaging structures of bottom lid member to secure said lower surface of said second tubular housing member at a position juxtaposed to the top surface of said bottom lid member,
a bottom lid member including an outer surface, a top surface and a lower surface, said top surface having conjugate engaging structures for cooperation with the internal engaging structures within the second tubular housing member,
a top member including an outer surface, a top surface, a lower surface and the bottom portion of said top member having a cylindrical convex carved maze pattern integrally formed to said top member, said cylindrical carved convex maze pattern of the top member is cylindrical in shape having an outer diameter surface that is sized to fit within said bottom portion of said upper internal bore of said tubular housing member,

4. The toothless herb grinder system of claim 3 wherein the bottom portion of said top member and the bottom portion of said upper internal bore of said first tubular housing member include maze pattern carvings when viewed from the top, whereby lines or other shapes are repeated along the radius, said lines or other shapes create a concave radius, said concave radius is repeated around the center of said top member and bottom portion of said upper internal bore of said first tubular housing member, said concave radiuses are positioned to be a concave beveled cutting edge when the bottom portion of said top member is being pressed against the bottom portion of said upper internal bore of said first tubular housing member with a rotating motion creating the scissoring intersection of the two patterns.

5. The toothless herb grinder system of claim 4 wherein said bottom portion of said concave radiuses of said first tubular housing member including sized apertures for sieving the ground material.

6. The toothless herb grinder system of claims 1 and 3 wherein said maze pattern carvings are achieved by machining any hard material such as wood or aluminum.
